(19) United States
(12) Patent Application Publication
(10) Pub. No.: US 2017/0034723 A1
(43) Pub. Date: Feb. 2, 2017

(54) Managing Tune Away During An Ongoing Voice Call

(71) Applicant: QUALCOMM Incorporated, San Diego, CA (US)

(72) Inventors: Raghavendra Shyam Anand, Chickballapur (IN); Himanshu Dutta, Hyderabad (IN); Anand Rajurkar, Hyderabad (IN); Kishore Kumar Yannakula, Hyderabad (IN); Suresh Sanka, Hyderabad (IN)

(21) Appl. No.: 14/813,328

(22) Filed: Jul. 30, 2015

(51) Int. Cl. H04W 24/08; H04W 68/00; H04W 8/18

(52) U.S. Cl. CPC H04W 24/08; H04W 8/183; H04W 68/005

(57) ABSTRACT

Embodiments include systems and methods for managing a tune away from a first network to a second network in a multi-subscription multi-standby communication device during an ongoing voice communication session on the first network. A device processor determine a timing of voice frames received from the first network. The device processor may perform a tune away to the second network at the beginning of a voice frame on the first network. In various embodiments, the device processor may use may use different tune-away patterns to reduce the impact of performing the tune away on the ongoing voice communication session.

### BACKGROUND

Wireless devices having multiple subscriber identity modules (SIMs) may communicate with two or more cells of a wireless network. Some multi-subscription multi-standby communication devices may allow two or more network interfaces or SIMs to share a single radio frequency (RF) resource (e.g., dual-SIM dual-standby, or “DSDS” devices). However, the RF resource in such devices can only tune to a single network at a time. The multi-subscription multi-standby communication device may employ a “tune-away” procedure to monitor multiple interfaces in a standby mode by tuning to one network in a primary cell, quickly tuning away to the second network in a second cell for a short time, and then tuning back to the first network to continue a voice or data call. This tune-away procedure may allow the multi-subscription multi-standby communication device to monitor for pages or other indications of incoming messages or data received on the second network (e.g., pages, short message service (SMS) messages, or other data), measure signal strength, and receive various control channel information. However, tuning away to another network may interrupt communications with the first network, and may degrade the quality of an ongoing voice call in the first network.

### SUMMARY

Various embodiments include methods and multi-subscription multi-standby communication devices implementing methods for managing a tune away from a first network to a second network during an ongoing voice communication session on the first network. Methods according to various embodiments may include determining a timing of voice frames received from the first network, and performing a tune away to the second network at the beginning of a voice frame on the first network. In some embodiments the methods may further include determining whether a tune-away activity is a critical tune-away activity, in which performing a tune away to the second network at the beginning of a voice frame on the first network may include aligning the tune-away activity to the beginning of a voice frame on the first network in response to determining that the tune-away activity is not a critical tune-away activity.

In some embodiments, performing a tune away to the second network at the beginning of a voice frame on the first network may include aligning the tune away to the beginning of a voice frame on the first network in response to determining that the tune-away activity is a critical tune-away activity.

In some embodiments the methods may further include determining communication link conditions of one or more of a first communication link with the first network and a second communication link with the second network, determining whether performing the tune away will degrade the ongoing voice communication session below a threshold based on the determined communication link conditions, and preventing the tune away to the second network in response to determining that performing the tune away will degrade the ongoing voice communication session below the threshold.

In some embodiments, performing a tune away to the second network at the beginning of a voice frame on the first network may include selecting a first tune-away pattern to perform the tune away, and the methods may further include selecting a second tune-away pattern in response to determining that a paging message is received from the second network, and performing the tune away using the second tune-away pattern. In various embodiments, the second tune-away pattern may be different than the first tune-away pattern.

In some embodiments, performing a tune away to the second network at the beginning of a voice frame on the first network may include selecting a first tune-away pattern to perform the tune away, and the methods may further include selecting a third tune-away pattern in response to determining that caller ID information is received from the second network, and performing the tune away using the third tune-away pattern. In various embodiments, the third tune-away pattern may be different than the second tune-away pattern and/or the first tune-away pattern.

In some embodiments the methods may further include selecting the second tune-away pattern in response to determining that an input is received rejecting an incoming communication session that is indicated by the caller ID information, and exchanging disconnection messaging with the second network using the second tune-away pattern. In some embodiments the methods may further include selecting the second tune-away pattern in response to determining that an input is received accepting an incoming communication session that is indicated by the caller ID information, and exchanging connection messaging with the second network using the second tune-away pattern. In some embodiments the methods may further include conducting a communication session that is established based on the exchanged connection messaging, and selecting the first tune-away pattern to monitor the first network during the communication session on the second network.

Various embodiments further include a multi-subscription multi-standby computing device having a memory, a radio frequency (RF) resource, and a processor coupled to the memory and the RF resource that is configured with processor executable instructions to perform operations of the methods described above. Various embodiments include a multi-subscription multi-standby computing device having means for performing functions of the methods described above. Various embodiments include a non-transitory processor-readable storage medium having stored thereon processor-executable instructions configured to cause a processor of a multi-subscription multi-standby computing device to perform operations of the methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of the various embodiments, and not to limit the various embodiments.

FIG. 1 is a component block diagram of a communication system suitable for use with various embodiments.

FIG. 2 is a component block diagram of a multi-subscription multi-standby communication device according to various embodiments.

FIG. 3 is a timing diagram illustrating voice frames of a voice communication session over a communication network.

FIG. 4 is a process flow diagram illustrating a method for managing a tune away from a first network to a second network during an ongoing voice communication session on the first network according to various embodiments.

FIG. 5 is another process flow diagram illustrating a method for managing a tune away from a first network to a second network during an ongoing voice communication session on the first network according to various embodiments.

FIG. 6 is another process flow diagram illustrating a method for managing tune away from a first network to a second network during an ongoing voice communication session on the first network according to various embodiments.

FIG. 7 is a component block diagram of a multi-subscription multi-standby communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods implemented in multi-subscription multi-standby communication devices that enable decoding of system information of a plurality of communication networks received by a processor of a multi-subscription multi-standby communication device that reduces the time required to receive the system information of all communication networks.

The term “multi-subscription multi-standby communication device” is used herein to refer to any one or all of cellular telephones, smartphones, personal or mobile multi-media players, personal data assistants, laptop computers, tablet computers, smartbooks, palmtop computers, wireless electronic mail receivers, multimedia Internet enabled cellular telephones, wireless gaming controllers, and similar electronic devices and portable computing platforms that include a programmable processor, a memory, and a shared radio frequency (RF) resource configured to support two or more subscriptions. Various embodiments may be particularly useful in any communication devices that can support multiple wireless wide area network subscriptions and receive cell broadcasts via the shared RF resource.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a multi-subscription multi-standby communication device and the multi-subscription multi-standby communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Multi-subscription multi-standby communication devices that allow two or more network interfaces or SIMs to share a single RF resource typically can only tune to a single network at a time. To support multiple subscriptions, a multi-subscription multi-standby communication device may employ a tune-away procedure to monitor multiple interfaces in which the multi-subscription multi-standby device tunes a shared RF resource to a first network (i.e., tuned to a carrier signal associated with the first network), tunes the RF resource away to a second network for a short time (i.e., tuning to another carrier signal of the second network), and then tunes the RF resource back to the first network to continue a voice or data call. This tune-away procedure may enable the multi-subscription multi-standby communication device to monitor system information from two or more communication networks. The tune-away procedure may also allow the multi-subscription multi-standby communication device to support an active call on a first subscription with a first network while monitoring for pages or other indications of incoming messages or data on a second subscription received from a second network.

References to “first network,” “first subscription,” “second network,” and “second subscription” are arbitrary and are used to refer to two or more subscriptions/networks generally because at any given time either subscription/network may be in an active mode (on an active voice or data call) or a standby mode, and all subscriptions/networks may need to monitor for system information (e.g., for network SIB transmissions). For example, at one time the multi-subscription multi-standby communication device may conduct an active communication session using a first subscription with a first network (and thus a “first subscription) while a second subscription with a second network is in a standby mode (and thus a “second” subscription), and at a later time the second subscription may enter an active data call (becoming the “first” subscription) and the first subscription may enter the standby mode (becoming the “second” subscription). Also, references to “first” and “second” subscriptions and networks are not intended to imply that the embodiments are limited to two subscriptions sharing one RF resource, because three or more subscriptions may share one RF resource provided that only one subscription can use the RF resource at a time. Third and fourth subscriptions would behave similar to a second subscription. Therefore, in the interest of brevity, operations of subscriptions in the standby mode that share the RF resource during tune-away periods are described generally with reference to the “second” subscription.

Multi-subscription multi-standby mobile communication devices may communicate with two or more cells of a wireless network. Multi-subscription multi-standby communication devices allow two or more network interfaces or SIMs to share an RF resource (which may be a part of a single receiver/transmitter chain) that can one be tuned to a single network at a time. One example of the multi-subscription multi-standby communication device is a DSDS communication device.

A multi-subscription multi-standby communication device may monitor multiple interfaces in a standby mode by using a tune-away procedure to monitor the second network for incoming messages or data, measure signal strength and perform other measurements, and receive various control channel information. However, tuning away to the second network may degrade the quality of an ongoing voice call in the first network by interrupting communication between the multi-subscription multi-standby communication device and the first network.

The various embodiments provide methods implemented by a processor in a multi-subscription multi-standby communication device that may manage tune away to a second network during an ongoing voice call on a first network so as to reduce the impact of the tune away on the ongoing voice call. In various embodiments, a multi-subscription multi-standby communication device that is conducting a voice communication session on a first network may determine a timing of voice frames received by the multi-subscription multi-standby communication device from the first network. In various embodiments, the multi-subscription multi-standby communication device may monitor communication link conditions a communication link with the second network, and may determine a number of bursts that need to be received by the multi-subscription multi-standby communication device in order to perform an activity on the second network during the tune away. Additionally or alternatively, in various embodiments, the multi-subscription multi-standby communication device may monitor communication link conditions of the communication link with the first network. In various embodiments, the multi-subscription multi-standby communication device may use the communication link conditions of the first and/or second communication links to determine the timing and/or duration of the tune away, as well as estimating any degradation of the voice communication session that may be caused by the tune away.

In various embodiments, the multi-subscription multi-standby communication device may schedule tune aways to the second network based on the voice frame timing of the first network. In various embodiments, the multi-subscription multi-standby communication device may schedule a tune away to the second network so as to align the tune away with the start of a voice frame. In various embodiments, if the required number of bursts can be received during the span of one voice frame, the tune away is ended. Otherwise, the tune away may be extended into a second voice frame. In various embodiments, the multi-subscription multi-standby communication device may also prevent the tune away if the impact on the voice call would be too severe (e.g., as compared to a threshold), based on channel conditions of the second network communication link, and/or channel conditions of the first network communication link. By aligning the beginning of the tune away to the second network with a voice frame of the first network, the multi-subscription multi-standby communication device may reduce the number of voice frames disrupted by a tune away.

In various embodiments, the multi-subscription multi-standby communication device may use different tune-away patterns to reduce the impact of performing the tune away on the ongoing voice communication session. Each tune-away pattern may allocate different proportions of time to each of the first and second networks. The multi-subscription multi-standby device may initially select a first tune-away pattern, in which the device may monitor the second network (e.g., for a paging message). In various embodiments, the multi-subscription multi-standby device may allocate substantially equal amounts of time in the first tune-away pattern to communications with the first and second networks.

In various embodiments, when the multi-subscription multi-standby communication device receives a paging message, the multi-subscription multi-standby communication device may select a second tune-away pattern. In various embodiments, the multi-subscription multi-standby communication device may allocate a substantially shorter time in the second tune-away pattern to the second communication network.

In various embodiments, when the multi-subscription multi-standby communication device receives caller ID information (or other similar identity information of the caller), the multi-subscription multi-standby communication device may switch to (i.e., select) a third tune-away pattern, in which the multi-subscription multi-standby communication device allocates just enough communication time to the second network to maintain the communication link with the second network. For example, the amount of time allocated to communication with the second network may be based on one or more “timeout” timers of the second network. The second network may use one or more timeout timers to determine whether a multi-subscription multi-standby communication device conducts network activity (e.g., respond to paging message, such as to accept or reject an incoming call request) within a duration of a timeout timer.

In some embodiments, the device processor may allocate within the second tune-away pattern an amount of time to communicate with the second network based on a first timeout timer of the second network. In some embodiments, the first timeout timer may include a duration of time during which the multi-subscription multi-standby communication device must respond to a paging message. In some embodiments, the device processor may allocate within the third tune-away pattern an amount of time to communicate with the second network based on a second timeout timer of the second network. In some embodiments, the second timeout timer may include a duration of time during which the multi-subscription multi-standby communication device must accept or reject an incoming paging message.

In various embodiments, the multi-subscription multi-standby communication device may use the third tune-away pattern until a timer expires, or until the device receives a user input accepting or rejecting the incoming call on the second network. In response to receiving a rejection of the call, the multi-subscription multi-standby communication device may switch to the second tune-away pattern to exchange disconnect messaging with the second network.

In various embodiments, in response to receiving a call acceptance, the multi-subscription multi-standby communication device may switch to the second tune-away pattern to exchange call connection messaging with the first network. The multi-subscription multi-standby communication device may then switch to the first tune-away pattern (i.e., may use the timing of the first tune-away pattern) to conduct the accepted call over the second network while periodically monitoring the first network for a page or other data, or to make measurements of the first network.

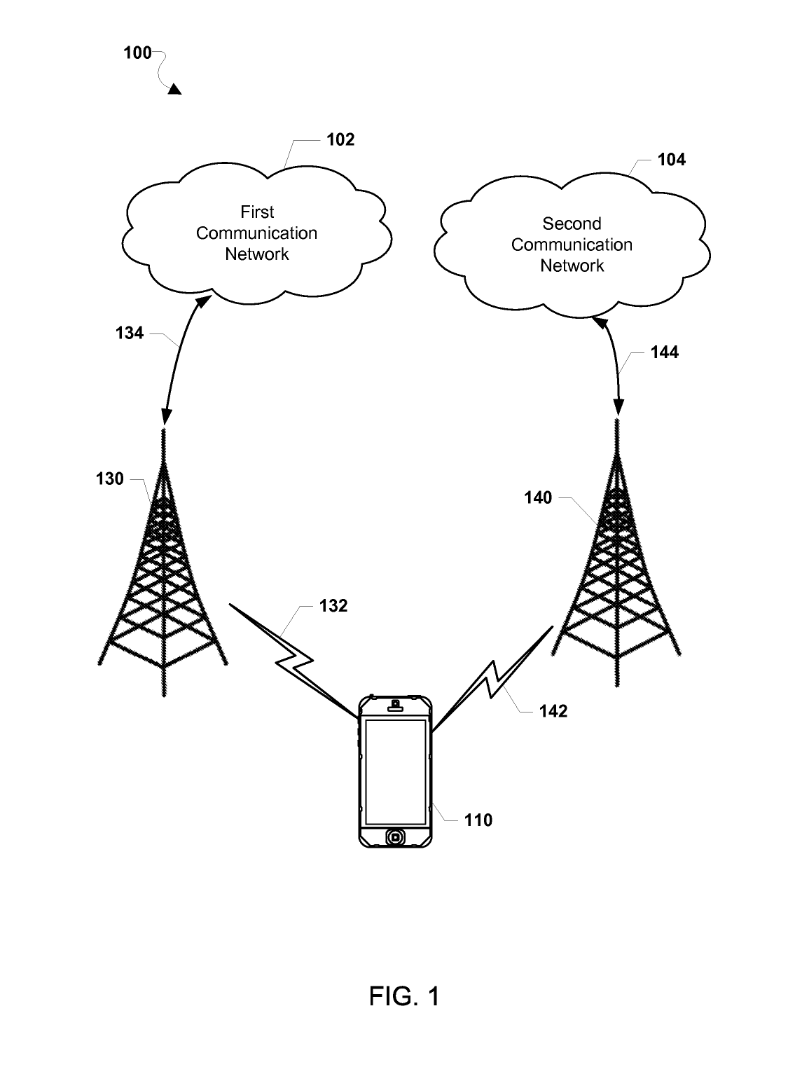

Various embodiments may be implemented within a variety of communication systems 100, such as systems that include at least two mobile communication networks, an example of which is illustrated in FIG. 1. A first communication network 102 and a second communication network 104 each may include a plurality of cellular base stations (e.g., a first base station 130 and a second base station 140). A multi-subscription multi-standby communication device 110 may communicate with the first communication network 102 through a communication link 132 to the first base station 130. The multi-subscription multi-standby communication device 110 may also communicate with the second communication network 104 through a communication link 142 to the second base station 140. The first base station 130 may communicate with the first communication network 102 over a wired or wireless communication link 134, and the second base station 140 may communicate with the second communication network 104 over a wired or wireless communication link 144. The communication links 134, 144 may include fiber optic backhaul links, microwave backhaul links, and other similar communication links.

Each of the communication networks 102 and 104 may support communications using one or more radio access technologies, and each of the communication links 132, 134, 142, 144 may include cellular connections that may be made through two-way wireless communication links using one or more radio access technologies (RATs). Examples of RATs may include 3GPP Long Term Evolution (LTE), Worldwide Interoperability for Microwave Access (WiMAX), Code Division Multiple Access (CDMA), Time Division Multiple Access (TDMA), Wideband CDMA (WCDMA), Global System for Mobility (GSM), and other RATs. While the communication links 132, 134, 142, 144 are illustrated as single links, each of the communication links may include a plurality of frequencies or frequency bands, each of which may include a plurality of logical channels. Additionally, each of the communication links 132, 134, 142, 144 may utilize more than one RAT.

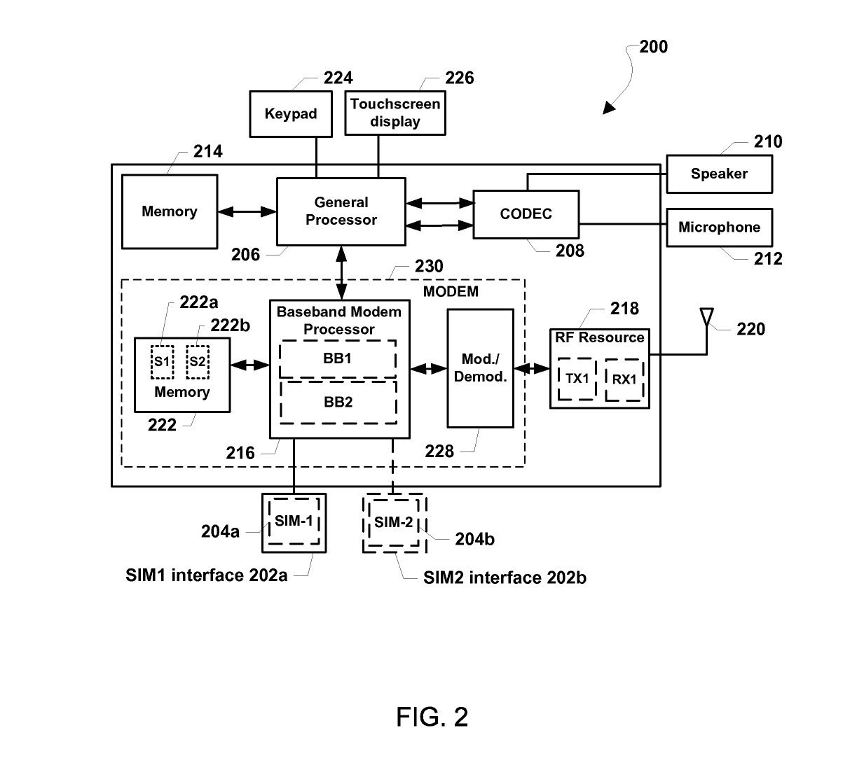

FIG. 2 is a component block diagram of a multi-subscription multi-standby communication device 200 suitable for implementing various embodiments. With reference to FIGS. 1 and 2, in various embodiments, the multi-subscription multi-standby communication device 200 may be similar to the multi-subscription multi-standby communication device 110. The multi-subscription multi-standby communication device 200 may include a first SIM interface 202a, which may receive a first identity module SIM-1 204a that is associated with a first subscription. The multi-subscription multi-standby communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM (Universal Subscriber Identity Module) applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The multi-subscription multi-standby communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to an RF resource 218 for transmission. The modulator/demodulator 228 may also extract an information-bearing signal from a modulated carrier wave received from the RF resource 218, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the multi-subscription multi-standby communication device 200 (e.g., SIM-1 204a, SIM-2 204b) may be coupled to the modem 230 and may be associated with or permitted to use the RF resource 218. In some embodiments, the RF resource 218 may use a common baseband modem processor 216 to perform baseband/modem functions for all RATs on the multi-subscription multi-standby communication device. In some embodiments, the RF resource 218 may include the physically or logically separate baseband processors (e.g., BB1, BB2).

The RF resource 218 may include transceivers associated with one or more RATs and may perform transmit/receive functions for the multi-subscription multi-standby communication device 200 on behalf of their respective RATs. The RF resource 218 may include separate transmit and receive circuitry. The RF resource 218 may be coupled to a wireless antenna (e.g., the wireless antenna 220). The RF resource 218 may also be coupled to the modem 230 (e.g., via the modulator/demodulator 228, or alternatively via the baseband modem processor 216 or another component).

In some embodiments, the general purpose processor 206, memory 214, baseband processor(s) 216, and the RF resource 218 may be included in the multi-subscription multi-standby communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the multi-subscription multi-standby communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-subscription multi-standby communication device 200 to enable communication between them.

Functioning together, the two SIMs 204a, 204b, the baseband processor(s) 216, the RF resources 218, and the antenna 220 may enable communications on two or more RATs. For example, one SIM, baseband processor and RF resource may be configured to support two different RATs. In other embodiments, more RATs may be supported on the multi-subscription multi-standby communication device 200 by adding more SIM cards, SIM interfaces, RF resources, and antennas for connecting to additional mobile networks.

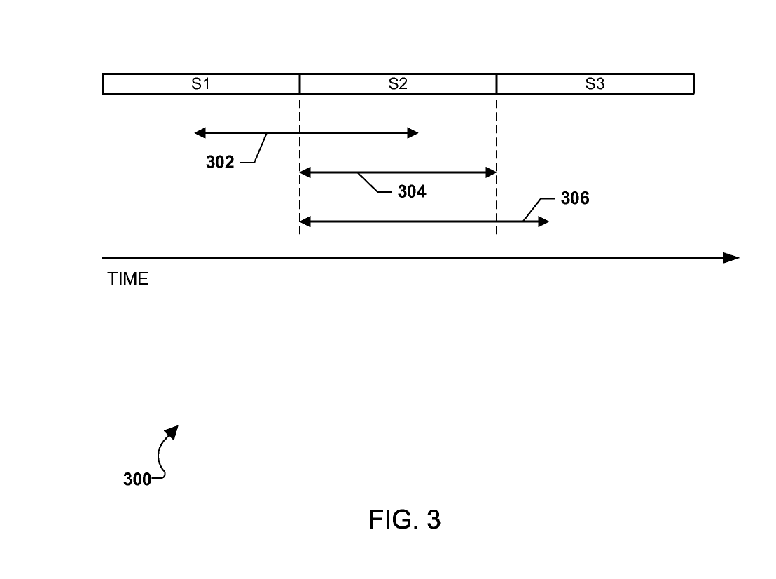

FIG. 3 illustrates a timing diagram 300 of voice frames of a voice communication session that may be transmitted by a communication network (e.g., from one of the base stations 130, 140 in FIG. 1) to a multi-subscription multi-standby communication device (e.g., the multi-subscription multi-standby communication device 110, 200 in FIGS. 1 and 2) according to some embodiments. With reference to FIGS. 1-3, speech frames S1, S2, and may S3 be transmitted from a communication network to a multi-subscription multi-standby communication device over time, such as during the conduct of a voice communication session.

To perform a tune-away activity 302, 304, 306, a multi-subscription multi-standby communication device may perform a tune away from a first communication network to a second communication network. To perform the tune-away activity 302, the communication device may perform a tune away during speech frame S1 and may conduct the tune-away activity 302 during the speech frames S1 and S2, thereby disrupting the voice communication session during both speech frames S1 and S2. If the communication device performs a tune-away activity (e.g., the tune-away activity 304) during only one speech frame, such as speech frame S2, the resulting disruption to the voice communication session occurs only during speech frame S2. The multi-subscription multi-standby communication device may thus begin the tune-away activity 304 at the beginning of the speech frame S2. In various embodiments, upon completion of the tune-away activity 304, the multi-subscription multi-standby communication device may tune back to the first communication network and continue to conduct the voice communication session.

In the event that the tune-away activity requires a greater amount of time to perform (e.g., the tune-away activity 306), the performance of the tune-away activity may be extended into the subsequent speech frame. For example, the tune-away activity 306 may require a greater amount of time than speech frame S2, and thus the multi-subscription multi-standby communication device may continue the tune-away activity 306 into speech frame S3. In various embodiments, upon completion of the tune-away activity 306, the multi-subscription multi-standby communication device may tune back to the first communication network and continue to conduct the voice communication session. Although the communication device may tune back to the first communication network after the beginning of speech frame S3, the multi-subscription multi-standby communication device may still receive some of the information (in many cases, most of the information) transmitted to the multi-subscription multi-standby communication device in the speech frame S3. Thus, by aligning the beginning of the tune away to the second network with a voice frame of the first network, the multi-subscription multi-standby communication device may reduce the number of voice frames disrupted by the tune away.

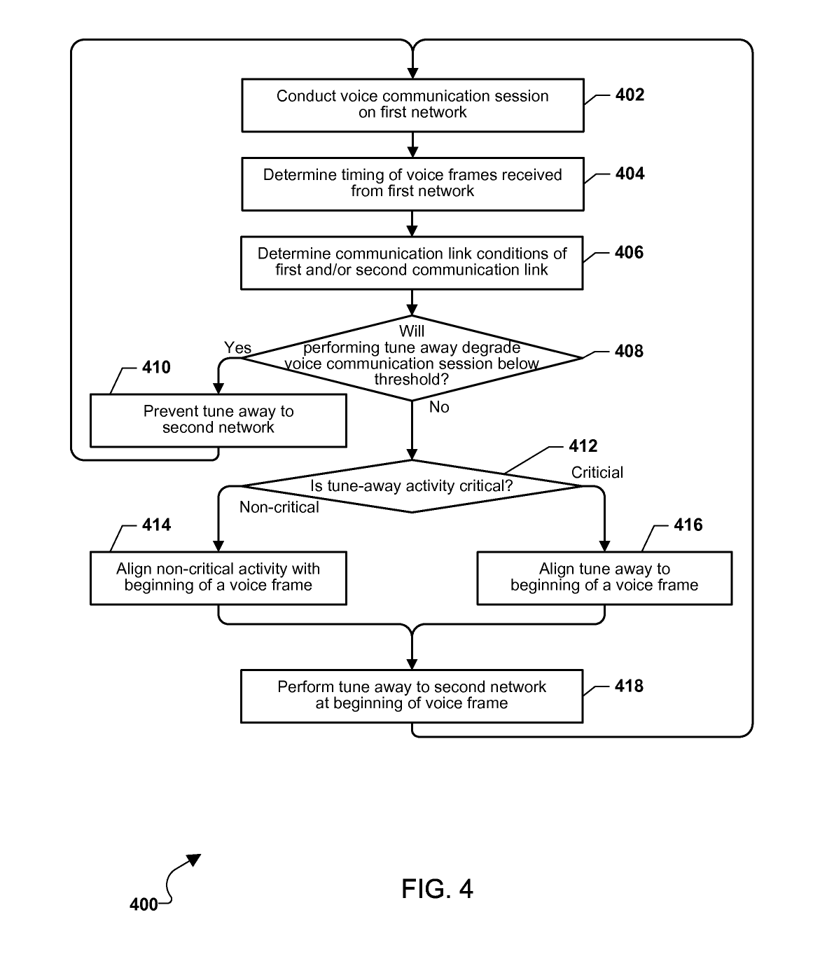

FIG. 4 illustrates a method 400 for managing a tune away from a first network to a second network during an ongoing voice communication session on the first network by a multi-subscription multi-standby communication device (e.g., the multi-subscription multi-standby communication device 110, 200 in FIGS. 1 and 2) according to various embodiments. With reference to FIGS. 1-4, the method 400 may be implemented by a processor (e.g., the general purpose processor 206, the baseband processor 216, a separate controller, and/or the like) of the multi-subscription multi-standby communication device (i.e., a device processor).

In block 402, the device processor may conduct a voice communication session on a first communication network (e.g., the first communication network 102) on a first subscription. In various embodiments, the device processor may conduct the voice communication session over a first communication link with the first communication network (e.g., the communication link 132). In block 404, the device processor may determine a timing of voice frames received from the first network (e.g., a timing of voice frames such as voice frames S1, S2, and S3). The device processor may thus determine the timing of the beginning of one or more voice frames that the multi-subscription multi-standby communication device expects to receive from the first communication network.

In block 406, the device processor may determine communication link conditions of the first communication link and/or a second communication link. In various embodiments, the second communication link may include a communication link between the multi-subscription multi-standby communication device and a second communication network (e.g., the communication link 142). In various embodiments, the communication link conditions may include a signal strength or signal strength indication, a signal quality or signal quality indication, a data throughput, a data rate, a data error rate (e.g., a block error rate or similar error rate indication), a level of RF interference, a modulation and coding scheme (MCS), and/or another communication link conditioning, including combinations of the foregoing.

In determination block 408, the device processor may determine whether a tune away will degrade the voice communication session below a threshold. The threshold may include one or more of a voice quality threshold, a throughput threshold, a data rate threshold, a data error rate threshold, or another threshold enabling the device processor to measure a degradation of the voice communication session. In various embodiments, the determination of whether the tune away will degrade the voice communication session below the threshold may be based on the determined communication link conditions of the first and/or second communication links. In response to determining that the tune away will degrade the voice communication session below the threshold (i.e., determination block 408=“Yes”), in block 410, the device processor may prevent the tune away to the second network. The device processor may return to the operations of block 402 and may repeat the operations of blocks 402-408.

In response to determining that the tune away will not degrade the voice communication session below the threshold (i.e., determination block 408=“No”), in determination block 412, the device processor may determine whether the tune-away activity is critical (i.e., is a critical activity). A critical tune-away activity may acquire performance at a time dictated by the second communication network, such as a paging cycle of the second communication network, or another message that the second communication network may send periodically or at a discreet time.

A non-critical tune-away activity may be performed by the multi-subscription multi-standby communication device at any time, but may not be dependent upon a timing of the second communication network. Examples of a non-critical tune-away activity include performing signal strength measurement, shared channel (SCH) detection, broadcast channel (BCH) monitoring, alternate frequency searches on the second communication network, and other similar activities that may be performed during a tune away.

In response to determining that the tune away-away activity is non-critical (i.e., determination block 412=“Non-critical”), the device processor may align the non-critical activity with the beginning of a voice frame of the first network (i.e., may schedule the performance of the non-critical activity at the beginning of a voice frame of the first network), in block 414. In block 418, the device processor may perform the tune away to the second network at the beginning of the voice frame. For example, the device processor may perform a signal strength measurement of one or more signals from the second communication network, or may perform shared channel (SCH) detection from the second medication network, commencing at the beginning of a voice frame of the first communication network.

In response to determining that the tune away-away activity is critical (i.e., determination block 412=“Critical”), the device processor may align the tune away activity with the beginning of a voice frame of the first network (i.e., may schedule the performance of the non-critical activity at the beginning of a voice frame of the first network), in block 416. In block 418, the device processor may perform the tune away to the second network at the beginning of the voice frame. For example, the device processor may perform a critical activity, such as monitoring the second communication network for paging message, commencing at the beginning of a voice frame of the first communication network. In various embodiments, the device processor may miss the beginning of a paging message or other message from the second communication network. In such case, the device processor may detect the paging message, and may extend the performance of the critical tune-away activity if needed to receive additional information from the second communication network.

Upon completion of the tune-away activity, the device processor may return to block 402, and may repeat the operations of blocks 402-418.

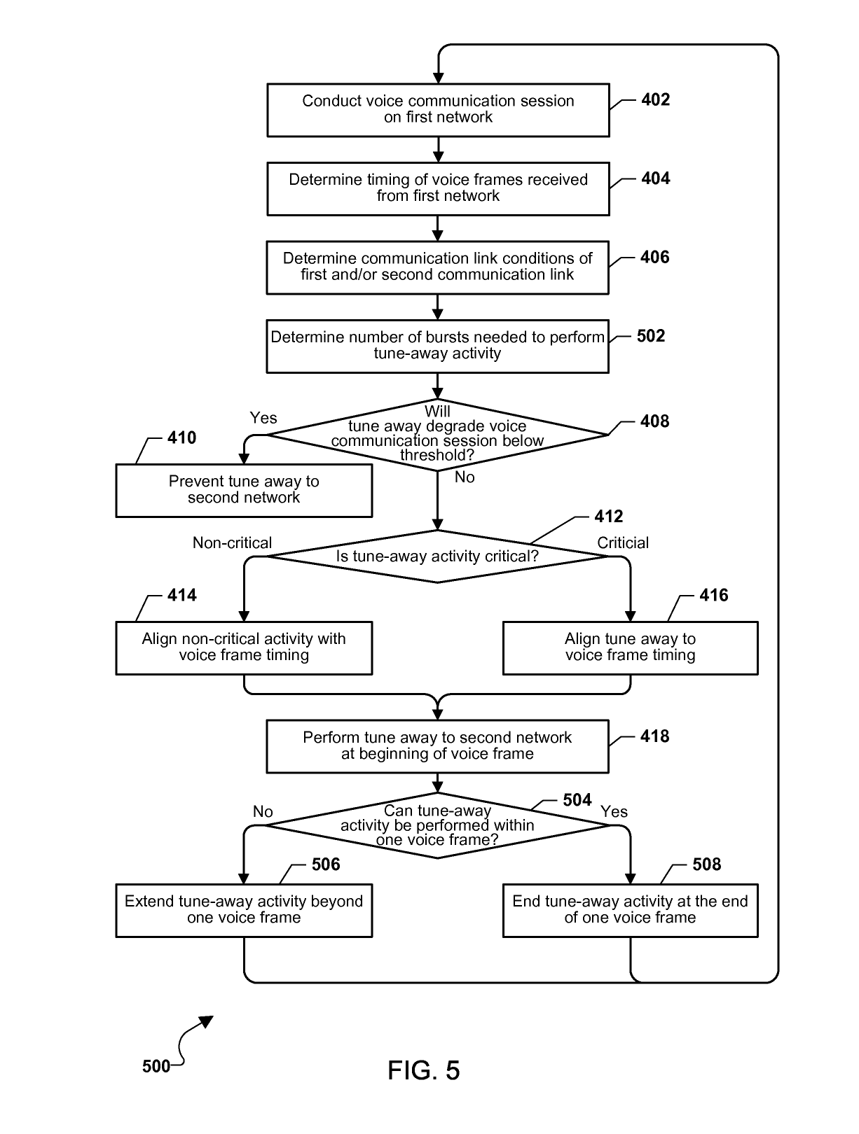

FIG. 5 illustrates a method 500 for managing a tune away from a first network to a second network during an ongoing voice communication session on the first network by a multi-subscription multi-standby communication device (e.g., the multi-subscription multi-standby communication device 110, 200 in FIGS. 1 and 2) according to various embodiments. With reference to FIGS. 1-5, the method 500 may be implemented by a processor (e.g., the general purpose processor 206, the baseband processor 216, a separate controller, and/or the like) of the multi-subscription multi-standby communication device (i.e., a device processor). In various embodiments of the operations performed in blocks 402-418, the device processor may perform operations similar to those described with reference to blocks 402-418 of the method 400.

In block 502, the device processor may determine a number of bursts needed to perform the tune-away activity. In some embodiments, a voice frame may include two or more bursts (or other subdivisions of the voice frame). For example, some tune-away activities, such as receiving a paging message, or neighbor cell acquisition (i.e., detection of the forward control channel (FCCH) or shared channel (SCH) of a cell or base station associated with the second medication network), may not require that the multi-subscription multi-standby communication device receive an entire data block (e.g., a voice frame). In some embodiments, certain tune-away activities may be performed within a single voice frame of the first network. The device processor may determine whether a tune-away activity may be performed within a single voice frame of the first network based on the number of bursts needed to perform the tune-away activity.

In determination block 504, the device processor may determine whether the tune-away activity can be performed within one voice frame. In response to determining that the tune-away activity cannot be performed within one voice frame (i.e., determination block 504=“No”), in block 506, the device processor may extend the tune-away activity beyond one voice frame. Upon completion of the tune-away activity, the device processor may return to block 402, and may repeat the operations of blocks 402-418.

In response to determining that the tune-away activity can be performed within one voice frame (i.e., determination block 504=“Yes”), in block 508, the device processor may and the tune-away activity at the end of the one voice frame.

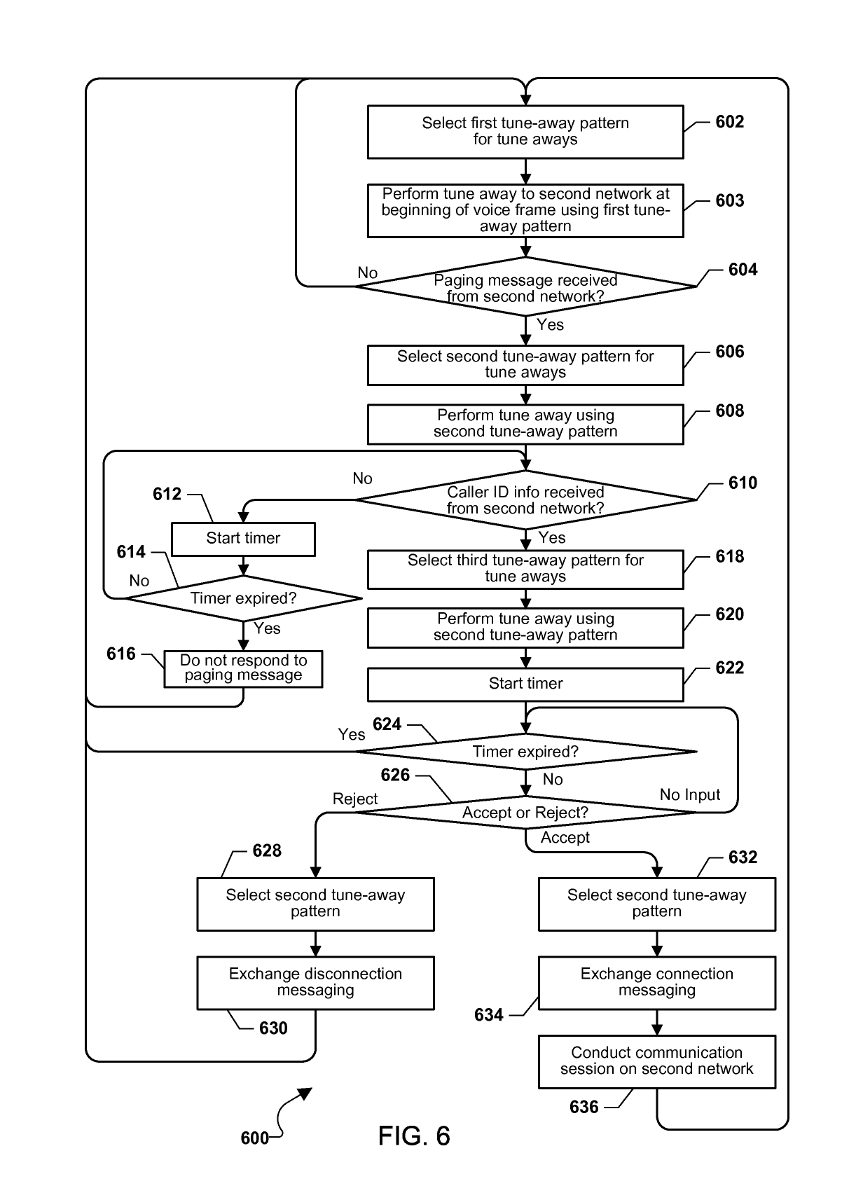

FIG. 6 illustrates a method 600 for a method for managing a tune away from a first network to a second network during an ongoing voice communication session on the first network by a multi-subscription multi-standby communication device (e.g., the multi-subscription multi-standby communication device 110, 200 in FIGS. 1 and 2) according to various embodiments. With reference to FIGS. 1-6, the method 600 may be implemented by a processor (e.g., the general purpose processor 206, the baseband processor 216, a separate controller, and/or the like) of the multi-subscription multi-standby communication device (i.e., a device processor). In various embodiments of the operations performed in block 418, the device processor may perform operations similar to those described with reference to block 418 of the method 400.

In various embodiments, the multi-subscription multi-standby communication device may select different tune-away patterns to reduce the impact of performing the tune away on the ongoing voice communication session. Each tune-away pattern may allocate different proportions of time to each of the first and second networks. Thus, in block 602, the device processor may select a first tune-away pattern to perform tune aways. In block 603, the device processor may perform a first tune away to the second network at the beginning of a voice frame using the first tune-away pattern. In various embodiments, the first tune-away pattern may allocate substantially equal amounts of time to communications with the first and second communication networks.

In determination block 604, the device processor may determine whether the device processor receives a paging message from the second communication network. In response to determining that the device processor has not received a paging message from the second communication network (i.e., determination block 604=“No”), the device processor may return to block 602 and may continue using the first tune-away pattern to perform tune aways.

In response to determining that the device processor has received a paging message from the second communication network (i.e., determination block 604=“Yes”), the device processor may select a second tune-away pattern to perform tune aways, in block 606. In other words, the arrival of the paging message may trigger the device processor to switch from the first tune-away pattern to the second tune-away pattern. In various embodiments, the second tune-away pattern may be different than the first tune-away pattern. In various embodiments, the second tune-away pattern may allocate a different amount of time, such as a substantially shorter time to the second communication network, sufficient to receive additional information from the second communication network while substantially reducing the effect on the ongoing voice command station session of any tune aways using the second tune-away pattern. In block 608, the device processor may perform a second tune away using the second tune-away pattern.

In determination block 610, the device processor may determine whether the device processor has received any caller ID information (or other similar identity information of the caller) from the second communication network. In response to determining that the device processor has not received any caller ID information (i.e., determination block 610=“No”), the device processor may start a timer, in block 612. In determination block 614, the device processor may determine whether the timer has expired. For example, the device processor may use a timer value based on a timeout timer of the second communication network. The timeout timer may include an amount of time during which the multi-subscription multi-standby communication device must respond to the paging message. In response to determining that the timer has not expired (i.e., determination block 614=“No”), the device processor may again determine whether the device processor has received any caller ID information from the second communication network, in determination block 610. In response to determining that the timer has expired (i.e., determination block 614=“Yes”), the device processor may not respond to the paging message, in block 616. For example, the paging message may include or represent a call request (i.e., an incoming call request for the multi-subscription multi-standby communication device), and in response to determining that the timer has expired, the device processor may not respond to the paging message, in effect dropping the call request. The device processor may then return to block 602 and repeat the operations of blocks 602-610.

In response to determining that the device processor has received caller ID information (i.e., determination block 610=“Yes”), the device processor may select a third tune-away pattern to perform tune aways, in block 618. For example, the arrival of caller ID information (or similar identity information) may trigger the device processor to switch from the second tune-away pattern to the third tune-away pattern. In various embodiments, the third tune-away pattern may be different than the first tune-away pattern and/or the second tune-away pattern. In various embodiments, the third tune-away pattern may allocate just enough communication time to the second network to maintain a communication link with the second network. For example, the amount of time allocated to communication with the second network in the third tune-away pattern may be based on one or more “timeout” timers of the second network, the expiration of which may trigger the second communication network to determine that the multi-subscription multi-standby communication device has not received the paging message, or has failed to respond to the paging message. In block 620, the device processor may perform a tune away using the third tune-away pattern.

In some embodiments, the second communication network may use one or more timeout timers to determine whether a communication device (such as the multi-subscription multi-standby communication device) conducts network activity (e.g., respond to paging message, or accept or reject an incoming call request) within a duration of a timeout timer. In some embodiments, the device processor may allocate within the second tune-away pattern an amount of time to communicate with the second communication network based on a first timeout timer of the second communication network. In some embodiments, the first timeout timer may include a duration of time during which the multi-subscription multi-standby communication device must respond to a paging message. In some embodiments, the device processor may allocate within the third tune-away pattern an amount of time to communicate with the second communication network based on a second timeout timer of the second communication network. In some embodiments, the second timeout timer may include a duration of time during which the multi-subscription multi-standby communication device must accept or reject an incoming paging message (e.g., to accept or reject a call request).

In block 622, the device processor may start a timer that may measure a time period during which the device processor may receive an acceptance or a rejection of the paging message (i.e., a response to the received paging message). In determination block 624, the device processor may determine whether the timer has expired. In response to determining that timer has expired (i.e., determination block 624=“Yes”), the device processor may return to block 602 and may select the first tune-away pattern for tune aways.

In response to determining that timer has not expired (i.e., determination block 624=“No”), the device processor may determine whether the device processor has received an acceptance response to the paging message, a rejection response to the paging message, or no input (i.e., no response) in determination block 626. In response to determining that the device processor has received no input (i.e., determination block 626=“No Input”), the device processor may return to determination block 624 and determine whether the timer has expired.

In response to determining that the device processor has received a rejection response to the paging message (i.e., determination block 626=“Reject”), in block 628, the device processor may select the second tune-away pattern to perform tune aways. In block 630, the device processor may exchange disconnection messaging with the second communication network using the second tune-away pattern. The disconnection messaging may include one or more messages, acknowledgments, or other messages exchanged between the multi-subscription multi-standby communication device and the second communication network to indicate that the device processor is rejecting the received paging message. The device processor may return to block 602 and may select the first tune-away pattern for tune aways.

In response to determining that the device processor has received an acceptance response to the paging message (i.e., determination block 626=“Accept”), in block 632, the device processor may select the second tune-away pattern to perform tune aways. In block 634, the device processor may exchange connection messaging with the second communication network using a second tune-away pattern. The connection messaging may include one or more messages, acknowledgments, or other messages exchanged between the multi-subscription multi-standby communication device and the second communication network to indicate that the device processor is accepting the received paging message (e.g., call request). The connection messaging may include requests to allocate network resources to establish a communication session between the multi-subscription multi-standby communication device and an originator of the paging message (e.g., call request).

In block 636, the device processor may conduct a communication session on the second communication network. Furthermore, while the device processor conducts the communication session on the second communication network, the device processor may use a first tune-away pattern to perform tune aways to the first communication network. For example, during the communication session on the second communication network, the device processor may use of the first tune-away pattern to perform tune aways to monitor the first communication network (e.g., for the arrival of paging message) to perform cell selection or reselection measurements, or other monitoring and/or measurement activities. At the conclusion of the communication session, the device processor may return to block 602 and may select the first tune-away pattern for tune aways.

Thus, the device processor in a multi-subscription multi-standby communication device may manage tune aways to a second network during an ongoing voice call on a first network so as to reduce the impact of the tune aways on the ongoing voice call.

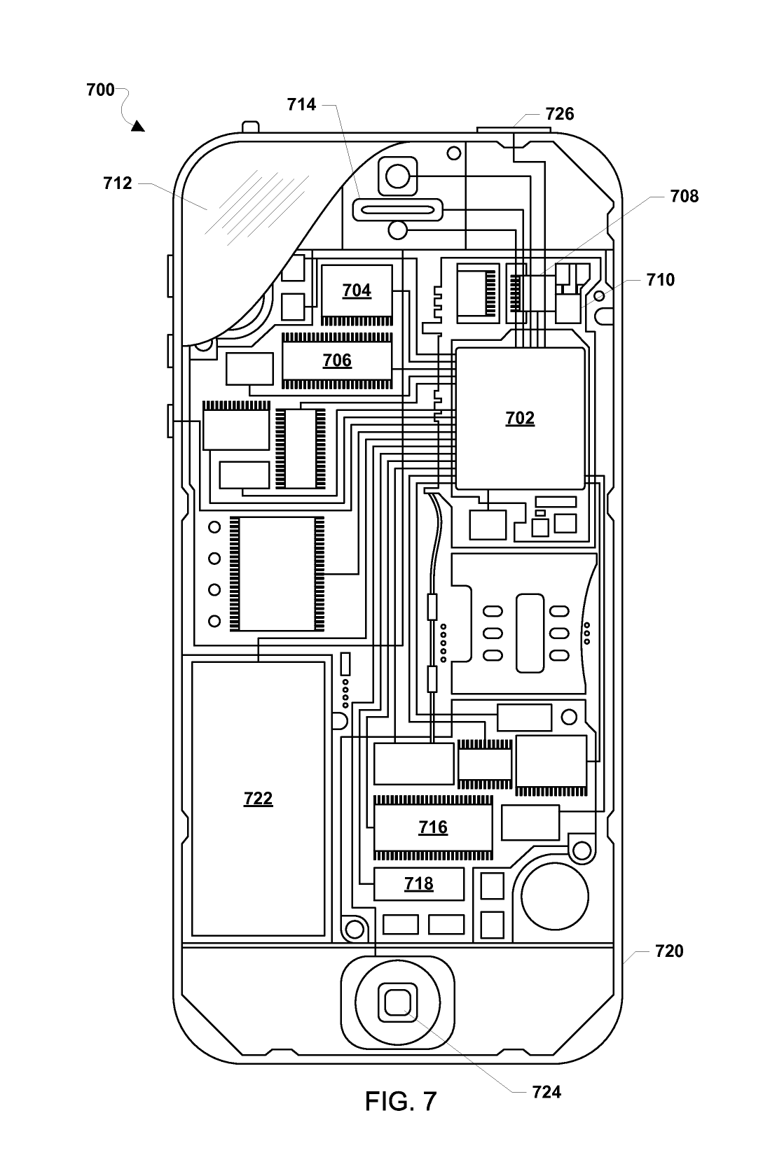

Various embodiments (including, but not limited to, embodiments described with reference to FIGS. 1-6) may be implemented in any of a variety of multi-subscription multi-standby communication devices, an example of which (e.g., multi-subscription multi-standby communication device 700) is illustrated in FIG. 7. In various embodiments, the multi-subscription multi-standby communication device 700 (which may correspond, for example, to the multi-subscription multi-standby communication devices 110 and 200 in FIGS. 1 and 2) may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the multi-subscription multi-standby communication device 700 need not have touch screen capability.

The multi-subscription multi-standby communication device 700 may have two or more radio signal transceivers 708 (e.g., Peanut, Bluetooth, ZigBee, Wi-Fi, RF radio) and antennae 710, for sending and receiving communications, coupled to each other and/or to the processor 702. The transceivers 708 and antennae 710 may be used with the above-mentioned circuitry to implement the various wireless transmission protocol stacks and interfaces. The multi-subscription multi-standby communication device 700 may include one or more cellular network wireless modem chip(s) 716 coupled to the processor and antennae 710 that enables communication via two or more cellular networks via two or more radio access technologies.

The multi-subscription multi-standby communication device 700 may include a peripheral device connection interface 718 coupled to the processor 702. The peripheral device connection interface 718 may be singularly configured to accept one type of connection, or may be configured to accept various types of physical and communication connections, common or proprietary, such as USB, FireWire, Thunderbolt, or PCIe. The peripheral device connection interface 718 may also be coupled to a similarly configured peripheral device connection port (not shown).

The multi-subscription multi-standby communication device 700 may also include speakers 714 for providing audio outputs. The multi-subscription multi-standby communication device 700 may also include a housing 720, constructed of a plastic, metal, or a combination of materials, for containing all or some of the components discussed herein. The multi-subscription multi-standby communication device 700 may include a power source 722 coupled to the processor 702, such as a disposable or rechargeable battery. The rechargeable battery may also be coupled to the peripheral device connection port to receive a charging current from a source external to the multi-subscription multi-standby communication device 700. The multi-subscription multi-standby communication device 700 may also include a physical button 724 for receiving user inputs. The multi-subscription multi-standby communication device 700 may also include a power button 726 for turning the multi-subscription multi-standby communication device 700 on and off.

The processor 702 may be any programmable microprocessor, microcomputer or multiple processor chip or chips that can be configured by software instructions (applications) to perform a variety of functions, including the functions of various embodiments described below. In some multi-subscription multi-standby communication devices, multiple processors 702 may be provided, such as one processor dedicated to wireless communication functions and one processor dedicated to running other applications. Typically, software applications may be stored in the internal memory 706 before they are accessed and loaded into the processor 702. The processor 702 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, the various embodiments are not intended to be limited to the embodiments shown herein but are to be accorded the widest scope consistent with the following claims and the principles and novel features disclosed herein.

What is claimed is:

1. A method for managing a tune away from a first network to a second network in a multi-subscription multi-standby communication device during an ongoing voice communication session on the first network, the method comprising:
determining a timing of voice frames received from the first network; and
performing a tune away to the second network at the beginning of a voice frame on the first network.

2. The method of claim 1, further comprising:
determining whether a tune-away activity is a critical tune-away activity, wherein
performing a tune away to the second network at the beginning of a voice frame on the first network comprises:
aligning the tune-away activity to the beginning of the voice frame on the first network in response to determining that the tune-away activity is not a critical tune-away activity.

3. The method of claim 2, wherein performing a tune away to the second network at the beginning of a voice frame on the first network comprises:
aligning the tune away to the beginning of the voice frame on the first network in response to determining that the tune-away activity is a critical tune-away activity.

4. The method of claim 1, further comprising:
determining communication link conditions of one or more of a first communication link with the first network and a second communication link with the second network;
determining whether performing the tune away will degrade the ongoing voice communication session below a threshold based on the determined communication link conditions; and
preventing the tune away to the second network in response to determining that performing the tune away will degrade the ongoing voice communication session below the threshold.

5. The method of claim 1,
wherein performing a tune away to the second network at the beginning of a voice frame on the first network comprises:
selecting a first tune-away pattern to perform the tune away; and
performing the tune away using the first tune-away pattern to the second network at the beginning of the voice frame on the first network;
wherein the method further comprises:
determining whether a paging message is received from the second network;
selecting a second tune-away pattern in response to determining that the paging message is received from the second network; and
performing the tune away using the second tune-away pattern.

6. The method of claim 5,
wherein the method further comprises:
determining whether caller ID information is received from the second network;
selecting a third tune-away pattern in response to determining that the caller ID information is received from the second network; and
performing the tune away using the third tune-away pattern.

7. The method of claim 6, further comprising:
selecting the second tune-away pattern in response to determining that an input is received rejecting an incoming communication session that is indicated by the caller ID information; and
exchanging disconnection messaging with the second network using the second tune-away pattern.

8. The method of claim 6, further comprising:
selecting the second tune-away pattern in response to determining that an input is received accepting an incoming communication session that is indicated by the caller ID information; and
exchanging connection messaging with the second network using the second tune-away pattern.

9. The method of claim 8, further comprising:
conducting, on the second network, a communication session that is established based on the exchanged connection messaging; and
selecting the first tune-away pattern to monitor the first network during the communication session on the second network.

10. A multi-subscription multi-standby communication device, comprising:
a memory;
a radio frequency resource; and
a processor coupled to the memory and the radio frequency resource and configured with processor-executable instructions to:
determine a timing of voice frames received from a first network during an ongoing voice communication session on the first network; and
perform a tune away to a second network at the beginning of a voice frame on the first network.

11. The multi-subscription multi-standby communication device of claim 10, wherein the processor is further configured with processor-executable instructions to:
determine whether a tune-away activity is a critical tune-away activity; and
align the tune-away activity to the beginning of the voice frame on the first network in response to determining that the tune-away activity is not a critical tune-away activity.

12. The multi-subscription multi-standby communication device of claim 11, wherein the processor is further configured with processor-executable instructions to align the tune away to the beginning of the voice frame on the first network in response to determining that the tune-away activity is a critical tune-away activity.

13. The multi-subscription multi-standby communication device of claim 10, wherein the processor is further configured with processor-executable instructions to:
determine communication link conditions of one or more of a first communication link with the first network and a second communication link with the second network;
determine whether performing the tune away will degrade the ongoing voice communication session below a threshold based on the determined communication link conditions; and
prevent the tune away to the second network in response to determining that performing the tune away will degrade the ongoing voice communication session below the threshold.

14. The multi-subscription multi-standby communication device of claim 10, wherein the processor is further configured with processor-executable instructions to:
select a first tune-away pattern to perform the tune away;
perform the tune away using the first tune-away pattern to the second network at the beginning of the voice frame on the first network;
determine whether a paging message is received from the second network;
select a second tune-away pattern in response to determining that the paging message is received from the second network; and
perform the tune away using the second tune-away pattern.

15. The multi-subscription multi-standby communication device of claim 14, wherein the processor is further configured with processor-executable instructions to:
determine whether caller ID information is received from the second network;
select the first tune-away pattern to perform the tune away;
select a third tune-away pattern in response to determining that the caller ID information is received from the second network; and
perform the tune away using the third tune-away pattern.

16. The multi-subscription multi-standby communication device of claim 15, wherein the processor is further configured with processor-executable instructions to:
select the second tune-away pattern in response to determining that an input is received rejecting an incoming communication session that is indicated by the caller ID information; and
exchange disconnection messaging with the second network using the second tune-away pattern.

17. The multi-subscription multi-standby communication device of claim 15, wherein the processor is further configured with processor-executable instructions to:
select the second tune-away pattern in response to determining that an input is received accepting an incoming communication session that is indicated by the caller ID information; and
exchange connection messaging with the second network using the second tune-away pattern.

18. The multi-subscription multi-standby communication device of claim 17, wherein the processor is further configured with processor-executable instructions to:
conduct, on the second network, a communication session that is established based on the exchanged connection messaging; and
select the first tune-away pattern to monitor the first network during the communication session on the second network.

19. A non-transitory processor-readable storage medium having stored thereon processor-executable instructions configured to cause a processor of a multi-subscription multi-standby communication device to perform operations for managing a tune away from a first network to a second network in the multi-subscription multi-standby communication device during an ongoing voice communication session on the first network, the operations comprising:
determining a timing of voice frames received from the first network; and
performing a tune away to the second network at the beginning of a voice frame on the first network.

20. The non-transitory processor-readable storage medium of claim 19, wherein the stored processor-executable instructions are configured to cause the processor of the multi-subscription multi-standby communication device to perform operations further comprising:
determining whether a tune-away activity is a critical tune-away activity,
wherein performing a tune away to the second network at the beginning of the voice frame on the first network comprises aligning the tune-away activity to the beginning of a voice frame on the first network in response to determining that the tune-away activity is not a critical tune-away activity.

21. The non-transitory processor-readable storage medium of claim 20, wherein the stored processor-executable instructions are configured to cause the processor of the multi-subscription multi-standby communication device to perform operations such that performing a tune away to the second network at the beginning of the voice frame on the first network comprises aligning the tune away to the beginning of a voice frame on the first network in response to determining that the tune-away activity is a critical tune-away activity.

22. The non-transitory processor-readable storage medium of claim 19, wherein the stored processor-executable instructions are configured to cause the processor of the multi-subscription multi-standby communication device to perform operations further comprising:
determining communication link conditions of one or more of a first communication link with the first network and a second communication link with the second network;
determining whether performing the tune away will degrade the ongoing voice communication session below a threshold based on the determined communication link conditions; and
preventing the tune away to the second network in response to determining that performing the tune away will degrade the ongoing voice communication session below the threshold.

23. The non-transitory processor-readable storage medium of claim 19, wherein the stored processor-executable instructions are configured to cause the processor of the multi-subscription multi-standby communication device to perform operations such that performing a tune away to the second network at the beginning of a voice frame on the first network comprises:
selecting a first tune-away pattern to perform the tune away; and
performing the tune away using the first tune-away pattern to the second network at the beginning of the voice frame on the first network;
wherein the stored processor-executable instructions are configured to cause the processor of the multi-subscription multi-standby communication device to perform operations further comprising:
determining whether a paging message is received from the second network;
selecting a second tune-away pattern in response to determining that the paging message is received from the second network; and
performing the tune away using the second tune-away pattern.

24. The non-transitory processor-readable storage medium of claim 23, wherein the stored processor-executable instructions are configured to cause the processor of the multi-subscription multi-standby communication device to perform operations further comprising:
determining whether caller ID information is received from the second network;
selecting a third tune-away pattern in response to determining that the caller ID information is received from the second network; and
performing the tune away using the third tune-away pattern.

25. The non-transitory processor-readable storage medium of claim 24, wherein the stored processor-executable instructions are configured to cause the processor of the multi-subscription multi-standby communication device to perform operations further comprising:
selecting the second tune-away pattern in response to determining that an input is received rejecting an incoming communication session that is indicated by the caller ID information; and
exchanging disconnection messaging with the second network using the second tune-away pattern.

26. The non-transitory processor-readable storage medium of claim 24, wherein the stored processor-executable instructions are configured to cause the processor of the multi-subscription multi-standby communication device to perform operations further comprising:
selecting the second tune-away pattern in response to determining that an input is received accepting an incoming communication session that is indicated by the caller ID information; and
exchanging connection messaging with the second network using the second tune-away pattern.

27. The non-transitory processor-readable storage medium of claim 26, wherein the stored processor-executable instructions are configured to cause the processor of the multi-subscription multi-standby communication device to perform operations further comprising:
conducting, on the second network, a communication session that is established based on the exchanged connection messaging; and
selecting the first tune-away pattern to monitor the first network during the communication session on the second network.

28. A multi-subscription multi-standby communication device, comprising:
means for determining a timing of voice frames received from a first network; and
means for performing a tune away to a second network at the beginning of a voice frame on the first network.
